(19) United States
(12) Patent Application Publication
(10) Pub. No.: US 2024/0239702 A1
(43) Pub. Date: Jul. 18, 2024

(54) APPARATUS AND METHOD FOR MANUFACTURING GLASS WITH DUAL PHASE AND ADJUSTABLE FLUID FLOW

(71) Applicant: CORNING INCORPORATED, CORNING, NY (US)

(72) Inventors: Tomohiro Aburada, Painted Post, NY (US); Anmol Agrawal, Horseheads, NY (US); Matthew John Cempa, Tyrone, PA (US); Miki Eugene Kunitake, San Diego, CA (US); Francisco Javier Moraga, Corning, NY (US); Shyam Prasad Mudiraj, Trappe, PA (US); Wenchao Wang, Ithaca, NY (US)

(21) Appl. No.: 18/559,683

(22) PCT Filed: Jun. 7, 2022
(86) PCT No.: PCT/US2022/032471

§ 371 Date: Nov. 8, 2023

Related U.S. Application Data
(60) Provisional application No. 63/212,863, filed on Jun. 21, 2021.
(60) Provisional application No. 63/342,273, filed on May 16, 2022.

(51) Int. Cl. C03B 35/18; C03B 13/04

(52) U.S. Cl. CPC C03B 35/184; C03B 13/04

(57) ABSTRACT

An apparatus and method for manufacturing glass include a heat extractor configured to extract heat from molten glass. The heat extractor includes a first conduit and at least one second conduit which may include a plurality of second conduits circumferentially surrounding the first conduit. The first conduit and the at least one second conduit are configured to flow a fluid therethrough.

### CROSS-REFERENCE TO RELATED APPLICATIONS

This application claims the benefit of priority under 35 U.S.C. § 119 of U.S. Provisional Application Ser. No. 63/212,863, filed on Jun. 21, 2021, the content of which is relied upon and incorporated herein by reference in its entirety.

This application further claims the benefit of priority under 35 U.S.C. § 119 of U.S. Provisional Application Ser. No. 63/342,273, filed on May 16, 2022, the content of which is relied upon and incorporated herein by reference in its entirety.

### FIELD

The present disclosure relates generally to an apparatus and method to manufacture glass and more specifically an apparatus and method to manufacture glass with dual phase and adjustable fluid flow.

### BACKGROUND

In the production of glass articles, such as glass sheets for display applications, including televisions and hand-held devices, such as telephones and tablets, molten glass can be formed into glass sheets by flowing the molten glass from a forming device. Such display applications include demand for increasingly flat thin glass. Depending on the viscosity of the glass flowing from the forming device, there may be a need to quickly change or adjust the glass viscosity in order to efficiently and reliably form glass articles with desired attributes.

### SUMMARY

Embodiments disclosed herein include an apparatus for manufacturing glass. The apparatus includes a heat extractor configured to extract heat from molten glass. The heat extractor includes a first conduit and at least one second conduit, which may include a plurality of second conduits circumferentially surrounding the first conduit. The first conduit and the at least one second conduit extend along a length of the heat extractor. Each of the first conduit and the at least one second conduit are configured to flow a fluid therethrough.

Embodiments disclosed herein also include a method for manufacturing glass. The method includes flowing molten glass from a glass delivery device. The method also includes extracting heat from the molten glass with a heat extractor. The heat extractor includes a first conduit and at least one second conduit, which may include a plurality of second conduits circumferentially surrounding the first conduit. The first conduit and the at least one second conduit extend along a length of the heat extractor. The extracting includes flowing a fluid through the first conduit and the at least one second conduit.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is a schematic perspective end view of an example glass manufacturing apparatus that includes an opposing pair of forming rolls in accordance with embodiments disclosed herein;

FIG. 3 is a schematic perspective end view of an example glass manufacturing apparatus that includes a single forming roll in accordance with embodiments disclosed herein;

FIG. 4 is a schematic perspective end view of an example glass manufacturing apparatus that includes a single forming roll and an opposing pair of forming rolls in accordance with embodiments disclosed herein;

FIG. 5 is a schematic end cutaway view of an example heat extractor in accordance with embodiments disclosed herein;

FIG. 6 is a schematic side cutaway view of an example heat extractor in accordance with embodiments disclosed herein;

FIG. 7 is a schematic side cutaway view of an example heat extractor and fluid transfer mechanism in accordance with embodiments disclosed herein;

FIG. 8 is a schematic perspective side view of an example glass manufacturing apparatus that includes a single forming roll in accordance with embodiments disclosed herein;

FIG. 9 is a schematic side view of an example heat extractor in accordance with embodiments disclosed herein;

FIGS. 10A and 10B are schematic end cutaways views of the example heat extractor of FIG. 9;

FIG. 11 is a schematic side view of an example fluid transfer mechanism in accordance with embodiments disclosed herein;

FIG. 12 is a schematic end cutaway view of the fluid transfer mechanism of FIG. 11;

FIG. 13 is a schematic side view of an example heat extractor in accordance with embodiments disclosed herein;

FIGS. 14A and 14B are schematic end cutaway views of the heat extractor of FIG. 13;

FIG. 15 is a schematic end cutaway view of a portion of the heat extractor of FIG. 14B;

FIG. 16 is a schematic side view of an example heat extractor in accordance with embodiments disclosed herein;

FIG. 17 is a schematic end cutaway view of the example heat extractor of FIG. 16;

FIG. 18 is a schematic side view of an example fluid transfer mechanism in accordance with embodiments disclosed herein;

FIG. 19A is a schematic side view of a portion of the fluid transfer mechanism of FIG. 18 and FIG. 19B is a schematic end cutaway view of the fluid transfer mechanism of FIG. 18;

FIG. 20 is a schematic side view of an example heat extractor in accordance with embodiments disclosed herein;

FIG. 21 is a schematic end cutaway view of the example heat extractor of FIG. 20;

FIG. 22 is a schematic end cutaway view of a portion of the heat extractor of FIG. 21;

FIG. 23 is a schematic side cutaway view of an example heat extractor in accordance with embodiments disclosed herein;

FIG. 24 is a schematic end cutaway view of the example heat extractor of FIG. 23;

FIG. 25 is a schematic end cutaway view of a portion of the heat extractor of FIG. 24;

FIGS. 26A and 26B are, respectively, schematic top and bottom views of an example nozzle in accordance with embodiments disclosed herein;

FIG. 27 is a schematic side cutaway view of an example heat extractor in accordance with embodiments disclosed herein;

FIG. 28 is a schematic end cutaway view of the example heat extractor of FIG. 27; and

FIG. 29 is a schematic end cutaway view of a portion of the heat extractor of FIG. 28.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein— for example up, down, right, left, front, back, top, bottom— are made only with reference to the figures as drawn and are not intended to imply absolute orientation.

Unless otherwise expressly stated, it is in way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “molten glass” refers to a glass composition that is at or above its liquidus temperature (the temperature above which no crystalline phase can coexist in equilibrium with the glass).

As used herein, the term “liquidus viscosity” refers to the viscosity of a glass composition at its liquidus temperature.

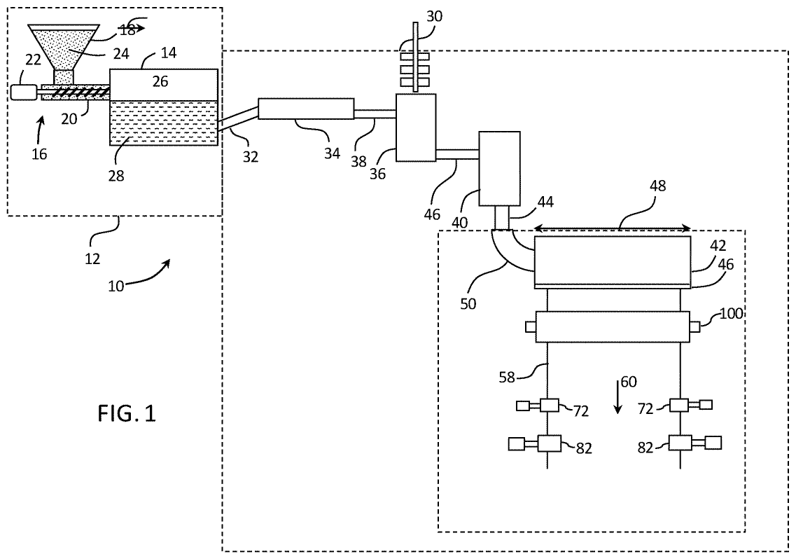

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 includes one or more additional components, such as heating elements (as will be described in more detail herein) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw batch materials 24 that can be fed into melting vessel 14 of glass melting furnace 12, as indicated by arrow 26. Raw batch materials 24 typically comprise one or more glass forming metal oxides and one or more modifying agents. In some examples, raw material delivery device 20 can be powered by motor 22 such that raw material delivery device 20 delivers a predetermined amount of raw batch materials 24 from the storage bin 18 to melting vessel 14. In further examples, motor 22 can power raw material delivery device 20 to introduce raw batch materials 24 at a controlled rate based on a level of molten glass sensed downstream from melting vessel 14. Raw batch materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 100% to about 60% by weight platinum and about 0% to about 40% by weight rhodium. However, other suitable metals can include molybdenum, rhenium, tantalum, titanium, tungsten and alloys thereof. Oxide Dispersion Strengthened (ODS) precious metal alloys are also possible.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process or cooled to a temperature lower than the temperature of the molten glass in the melting vessel before entering the fining vessel.

Bubbles may be removed from molten glass 28 within fining vessel 34 by various techniques. For example, raw batch materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to delivery device 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced delivery device 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Delivery device 42 in a slot draw glass making apparatus can comprise a delivery orifice (e.g., slot) 46 through which molten glass flows to produce a single glass ribbon 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may be contacted with an opposing pair of forming rolls 100 positioned downstream of delivery device 42.

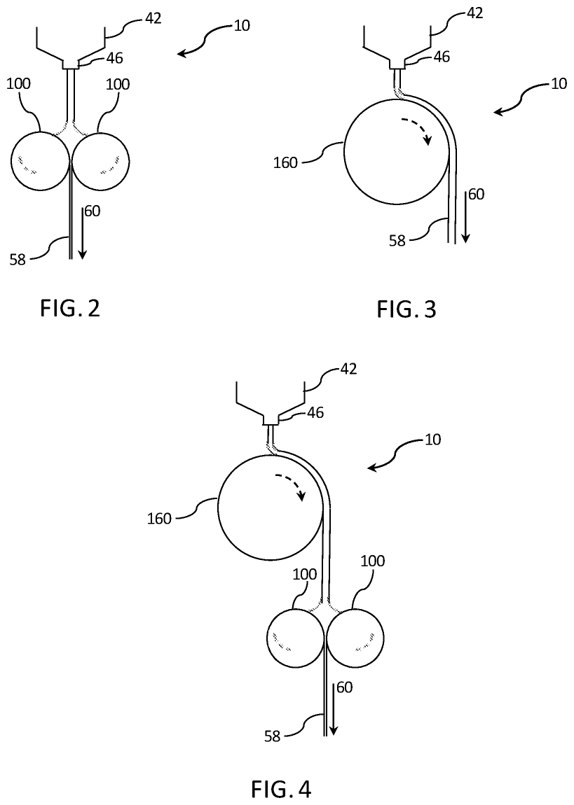

FIG. 2 shows a schematic perspective end view of an example glass manufacturing apparatus 10 that includes an opposing pair of forming rolls 100 in accordance with embodiments disclosed herein. Specifically, FIG. 2 shows flowing molten glass through delivery orifice (e.g. slot) 46 of glass delivery device 42 in draw direction 60 to form glass ribbon 58. In addition, FIG. 2 shows contacting opposing sides of glass ribbon 58 with an opposing pair of forming rolls 100 positioned downstream of glass delivery device 42 in draw direction 60, each forming roll 100 of the opposing pair extending along the widthwise direction (shown as ‘W’ in FIG. 8) of opposing sides of glass ribbon 58. Each of the forming rolls 100 may, for example, rotate in the clockwise direction (as indicated by dashed, curved arrows).

FIG. 3 shows a schematic perspective end view of an example glass manufacturing apparatus 10 that includes a single forming roll 160 in accordance with embodiments disclosed herein. Specifically, FIG. 3 shows flowing molten glass through delivery orifice (e.g. slot) 46 of glass delivery device 42 in draw direction 60 to form glass ribbon 58. In addition, FIG. 3 shows contacting a first side of glass ribbon 58 with a single forming roll 160 positioned downstream of glass delivery device 42, in draw direction 60, single forming roll 160 extending along the widthwise direction (shown as ‘W’ in FIG. 8) of a first side of glass ribbon 58. Single forming roll 160 may, for example, rotate in the clockwise direction (as indicated by dashed, curved arrow).

FIG. 4 shows a schematic perspective end view of an example glass manufacturing apparatus 10 that includes a single forming roll 160 and an opposing pair of forming rolls 100 in accordance with embodiments disclosed herein. Specifically, FIG. 4 shows flowing molten glass through delivery orifice (e.g. slot) 46 of glass delivery device 42 in draw direction 60 to form glass ribbon 58. In addition, FIG. 4 shows contacting a first side of glass ribbon 58 with a single forming roll 160 positioned downstream of glass delivery device 42, in draw direction 60 and further contacting opposing sides of glass ribbon 58 with an opposing pair of forming rolls 100 positioned downstream of single forming roll 160 in draw direction 60.

FIG. 5 shows a schematic end cutaway view of an example heat extractor 200 in accordance with embodiments disclosed herein. Heat extractor 200 is configured to contact glass ribbon 58 and is rotatable relative to glass ribbon 58. Heat extractor 200 includes single forming roll 160 wherein forming roll 160 includes first conduit 162 and plurality of second conduits 164 circumferentially surrounding first conduit 162. Alternatively stated, heat extractor 200 comprises a substantially cylindrical body of which first conduit 162 extends along a central axis. As shown in FIG. 5, the diameter of first conduit 162 is larger than the diameter of any of the plurality of second conduits 164. For example, the diameter of first conduit 162 may be at least about two times, such as at least about three times, and further such as at least about four times the diameter of any of the plurality of second conduits 164, including from about two times to about ten times, and further including from about three times to about six times the diameter of any of the plurality of second conduits 162. And while FIG. 5 shows eight second conduits 164, embodiments disclosed herein include those in which heat extractor 200 comprises any number of second conduits 164.

Embodiments disclosed herein include those in which first conduit 162 is configured to flow a liquid therethrough and the plurality of second conduits 164 are configured to flow a gas therethrough. In certain exemplary embodiments, the liquid can be or comprise water and the gas can be or comprise air. Embodiments disclosed herein can also include those in which the liquid and/or gas comprise, for example, organic liquids, nitrogen, helium, neon, or argon.

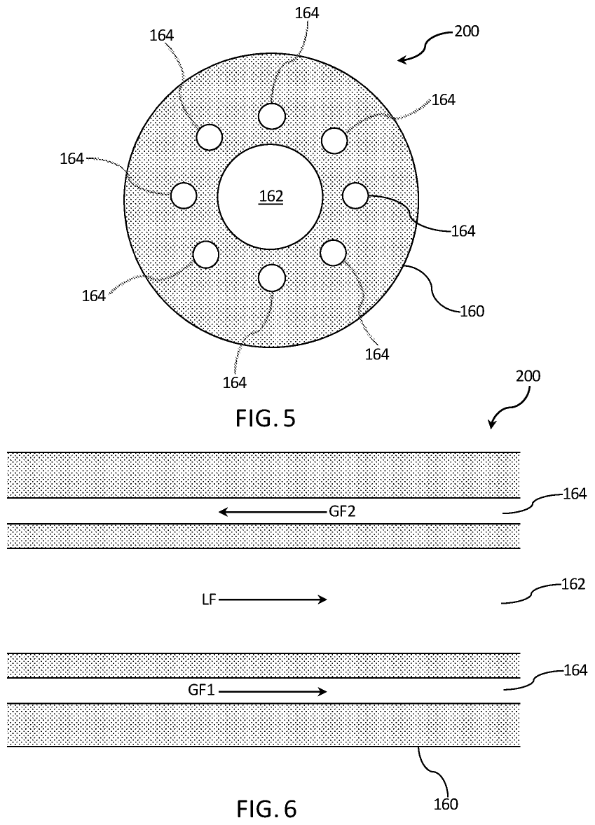

FIG. 6 shows a schematic side cutaway view of an example heat extractor 200 in accordance with embodiments disclosed herein. Specifically, FIG. 6 shows a schematic side cutaway view of the example heat extractor 200 shown in FIG. 5, wherein heat extractor 200 includes single forming roll 160 wherein forming roll 160 includes first conduit 162 and plurality of second conduits 164 circumferentially surrounding first conduit 162.

As shown in FIG. 6, first conduit 162 is configured to flow the liquid in a first direction along the length of the heat extractor 200 (shown in FIG. 6 as LF), at least one of second conduits 164 is configured to flow the gas in the first direction (shown in FIG. 6 as GF1), and at least one of second conduits 164 is configured to flow the gas in an opposing second direction along the length of the heat extractor 200 (shown in FIG. 6 as GF2) such that, in operation, the liquid flows in first conduit 162 in a first direction (LF) along the length of the heat extractor 200, a gas flows in at least one of second conduits 164 in the first direction (GF1), and a gas flows in at least one of second conduits 164 in an opposing second direction (GF2) along the length of the heat extractor 200.

In certain exemplary embodiments, such as that shown in FIG. 5, gas may flow in opposing directions in alternating second conduits 164 circumferentially surrounding first conduit 162 of heat extractor 200. For example, in a first of second conduits 164, gas may flow in a first direction along the length of the heat extractor 200 while, in an adjacent second of second conduits 164, gas may flow in an opposing second direction along the length of the heat extractor 200, and so forth for all of the second conduits 164 circumferentially surrounding first conduit 162 of heat extractor 200.

Accordingly, embodiments disclosed herein include those in which gas flows in a first direction along half of second conduits 164 of heat extractor 200 and flows in an opposing second direction along the other half of second conduits 164 of heat extractor 200. Embodiments disclosed herein also include those in which gas flows in a first direction along more than half of second conduits 164 of heat extractor 200 and flows in an opposing second direction along less than half of second conduits 164 of heat extractor 200. Embodiments disclosed herein also include those in which gas flows in a first direction along less than half of second conduits 164 of heat extractor 200 and flows in an opposing second direction along more than half of second conduits 164 of heat extractor 200.

Flowing gas in opposing directions along different second conduits 164 of heat extractor 200 can enable a more uniform temperature distribution along the length of heat extractor 200. For example, as shown in FIG. 8, heat extractor 200 comprising single forming roll 160 can further comprise a first end 160a proximate a first widthwise end 58a of glass ribbon 58 and a second end 160b proximate a second widthwise end 58b of glass ribbon 58, wherein a surface temperature (T1) of the first end 160a of the heat extractor 200 is within about 5° C., such as within about 3ºC, and further such as within about 1ºC, including from within about 0.5° C. to about 5° C. of a surface temperature (T2) of the second end 160b of the heat extractor 200.

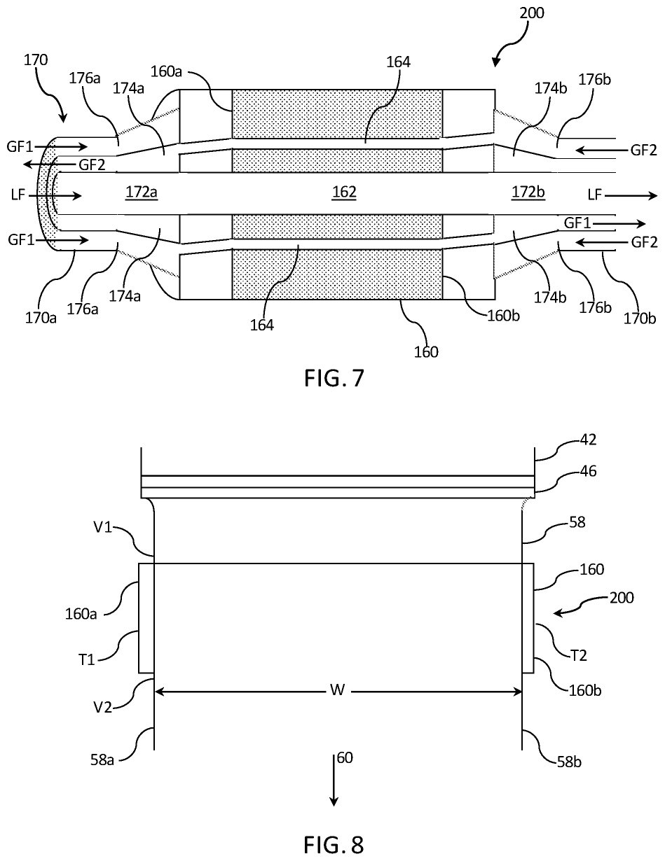

FIG. 7 shows a schematic side cutaway view of an example heat extractor 200 and fluid transfer mechanism 170 in accordance with embodiments disclosed herein. Heat extractor 200 includes single forming roll 160 wherein forming roll 160 is rotatable relative to glass ribbon 58 and includes first conduit 162 and plurality of second conduits 164 circumferentially surrounding first conduit 162. Fluid transfer mechanism 170 includes a first section 170a in fluid communication with first end 160a of heat extractor 200 and a second section 170b in fluid communication with second end 160b of the heat extractor 200. In addition, each of first and second sections 170a, 170b of fluid transfer mechanism 170 include a gas inlet conduit 176a, 176b configured to feed gas into the plurality of second conduits 164 of heat extractor 200 and a gas outlet conduit 174a, 174b configured to receive gas from the plurality of second conduits 164 of heat extractor 200. Additionally, first section 170a of fluid transfer mechanism 170 includes a liquid inlet conduit 172a configured to feed liquid into first conduit 162 of heat extractor 200 and second section 170b of fluid transfer mechanism 170 includes a liquid outlet conduit 172b configured to receive liquid from first conduit 162 of heat extractor 200. In addition, in each of the first and second sections 170a, 170b of fluid transfer mechanism 170, gas inlet conduit 176a, 176b circumferentially surrounds gas outlet conduit 174a, 174b while, in first section 170a, gas outlet conduit 174a circumferentially surrounds liquid inlet conduit 172a and, in the second section, gas outlet conduit 174b circumferentially surrounds liquid outlet conduit 172b. Gas flow into first section 170a of fluid transfer mechanism 170 (and out of second section 170b of fluid transfer mechanism 170) is shown as GF1, gas flow into second section 170b of fluid transfer mechanism (and out of first section 170a of fluid transfer mechanism 170) is shown as GF2 while liquid flow in and out of fluid transfer mechanism 170 is shown as LF.

In certain exemplary embodiments, such those shown in FIGS. 5-8 wherein heat extractor comprises single forming roll 160, a viscosity of the glass ribbon 58 prior to contacting the forming roll 160 (shown as V1 in FIG. 8) ranges from about 1 poise (P) to about 10 kilopoise (kP), such as from about 10 poise (P) to about 1 kilopoise (kP), and the viscosity of the glass ribbon 58 subsequent to contacting the forming roll 160 (shown as V2 in FIG. 8) ranges from about 50 kilopoise (kP) to about 500 kilopoise (kP), such as from about 100 kilopoise (kP) to about 200 kilopoise (kP).

And while heat extractor 200 is shown in FIGS. 5-8 as including single forming roll 160, embodiments disclosed herein include those in which heat extractor 200 includes other glass manufacturing components, such as opposing pair of forming rolls 100 and/or heat extracting components (not shown) that are not configured to contact molten glass and/or glass ribbon 58.

In certain exemplary embodiments, single forming roll 160 can be configured in accordance with forming rolls shown and described in WO2009/070236, the entire disclosure of which is incorporated herein by reference. Single forming roll 160 can be configured so as to provide a controllable adhesion force between the forming roll 160 and the glass ribbon 58. The diameter of single forming roll 160, while not limited to any particular value, may, for example, range from about 50 millimeters to about 500 millimeters and all ranges and subranges in between. In addition, single forming roll 160 may comprise a refractory material, which, while not limited to any particular refractory material, may comprise a metallic material (e.g., stainless steel and/or nickel and/or cobalt-based alloys and/or nickel-chromium based superalloys, e.g., Inconel) and/or a refractory ceramic material.

In certain exemplary embodiments, forming rolls 100 can be configured in accordance with forming rolls shown and described in WO2009/070236, the entire disclosure of which is incorporated herein by reference. The diameter of forming rolls 100 while not limited to any particular value, may, for example, range from about 20 millimeters to about 400 millimeters and all ranges and subranges in between. In addition, forming rolls 100 may comprise a refractory material, which, while not limited to any particular refractory material, may comprise a metallic material (e.g., stainless steel and/or nickel and/or cobalt-based alloys and/or nickel-chromium based superalloys, e.g., Inconel) and/or a refractory ceramic material.

In certain exemplary embodiments, heat extractor 200 comprises a material having a thermal conductivity at 25° C. ranging from about 10 W/m·K to about 500 W/m·K, such as from about 15 W/m·K to about 300 W/m·K, and further such as from about 20 W/m·K to about 100 W/m·K. In certain exemplary embodiments, heat extractor 200 comprises at least one material selected from Inconel, stainless steel, nickel, chromium, cobalt, silver, gold, platinum, aluminum, molybdenum, tungsten, or copper.

In certain exemplary embodiments, liquid flowing through first conduit 162 has a temperature of at least about 20° C., such as a temperature ranging from about 20° C. to about 100° C., such as from about 30° C. to about 90° C., and further such as from about 40° C. to about 80° C. In certain exemplary embodiments, gas flowing through one or more of second conduits 164 as a temperature of at least about 20° C., such as a temperature ranging from about 20° C. to about 600° C., such as from about 30° C. to about 500° C., and further such as from about 40° C. to about 400° C.

Delivery device 42 may, for example, be comprised of a refractory which, while not limited to any particular refractory material, may comprise a metallic material (e.g., platinum or an alloy thereof) and/or a refractory ceramic material.

A closest distance between delivery device 42 (e.g., delivery orifice 46) and single forming roll 160, while not limited to any particular value, may, for example, range from about 2 millimeters to about 5 meters and all ranges and subranges in between.

A closest distance between delivery device 42 (e.g., delivery orifice 46) and forming rolls 100 at their closest point (i.e., their nip distance), while not limited to any particular value, may, for example, range from about 2 millimeters to about 5 meters and all ranges and subranges in between.

In certain exemplary embodiments, molten glass flowing from delivery device 42 can comprise a liquidus viscosity of less than or equal to about 100 kilopoise (kP), such as a liquidus viscosity ranging from about 100 poise (P) to about 100 kilopoise (kP), and further such as a liquidus viscosity ranging from about 500 poise (P) to about 50 kilopoise (kP), and yet further such as a liquidus viscosity ranging from about 1 kilopoise (kP) to about 20 kilopoise (kP) and all ranges and subranges in between.

In certain exemplary embodiments, molten glass flowing from forming device (e.g., delivery device 42) can comprise a liquidus temperature of greater than or equal to about 900° C., such as a liquidus temperature ranging from about 900° C. to about 1,450° C., and further such as a liquidus temperature ranging from about 950° C. to about 1,400° C., and yet further such as a liquidus temperature ranging from about 1,000° C. to about 1,350° C.

In certain exemplary embodiments, incident and/or subsequent to contact with at least one forming rolls 160 or 100, glass ribbon 58 has a thickness of less than about 0.5 millimeters, such as a thickness of less than about 0.4 millimeters, and further such as a thickness of less than about 0.3 millimeters, and yet further such as a thickness of less than about 0.2 millimeters, such as a thickness of from about 0.1 millimeters to about 0.5 millimeters, including a thickness of about 0.2 millimeters to about 0.4 millimeters.

In certain exemplary embodiments, heat extractor 200 can be used to extract varying amounts of heat from molten glass flowing from delivery device 42. For example, it may be desirable to increase or decrease the amount of heat extracted from the molten glass as a function of a variety of operating conditions, including, but not limited to, flowrate of the molten glass, temperature of the molten glass, viscosity of the molten glass, liquidus viscosity of the molten glass, liquidus temperature of the molten glass, desired width of the glass ribbon 58, or desired thickness of the glass ribbon 58.

In certain exemplary embodiments, the amount of heat extracted from molten glass flowing from delivery device 42 can be adjusted or changed by changing one or more parameters of at least one fluid flowing through heat extractor 200. For example, the amount of heat extracted from molten glass flowing from delivery device 42 can be adjusted or changed by changing at least one of a flowrate of liquid through first conduit 162, a temperature of liquid flowing through first conduit 162, a flowrate of at least one gas through at least one of the plurality of second conduits 164, or a temperature of at least one gas flowing through at least one of the plurality of second conduits 164.

For example, the amount of heat extracted from molten glass flowing from delivery device 42 may be increased by increasing a flowrate of liquid through first conduit 162, decreasing a temperature of liquid flowing through first conduit 162, increasing a flowrate of at least one gas through at least one of the plurality of second conduits 164, or decreasing a temperature of at least one gas flowing through at least one of the plurality of second conduits 164.

In addition, the amount of heat extracted from molten glass flowing from delivery device 42 may be decreased by decreasing a flowrate of liquid through first conduit 162, increasing a temperature of liquid flowing through first conduit 162, decreasing a flowrate of at least one gas through at least one of the plurality of second conduits 164, or increasing a temperature of at least one gas flowing through at least one of the plurality of second conduits 164.

In certain exemplary embodiments, a control mechanism (not shown), such as a feedback or feedforward control mechanism may be used to control or adjust the amount of heat extracted from molten glass and/or glass ribbon 58, wherein the control mechanism can measure or monitor at least one condition of the molten glass and/or glass ribbon 58 at one or more locations. Such condition or conditions include but are not limited to temperature, viscosity, thickness, and/or flowrate of the molten glass and/or glass ribbon 58. In response to one or more of said conditions, control mechanism can, for example, control or adjust one or more parameters of at least one fluid flowing through heat extractor 200.

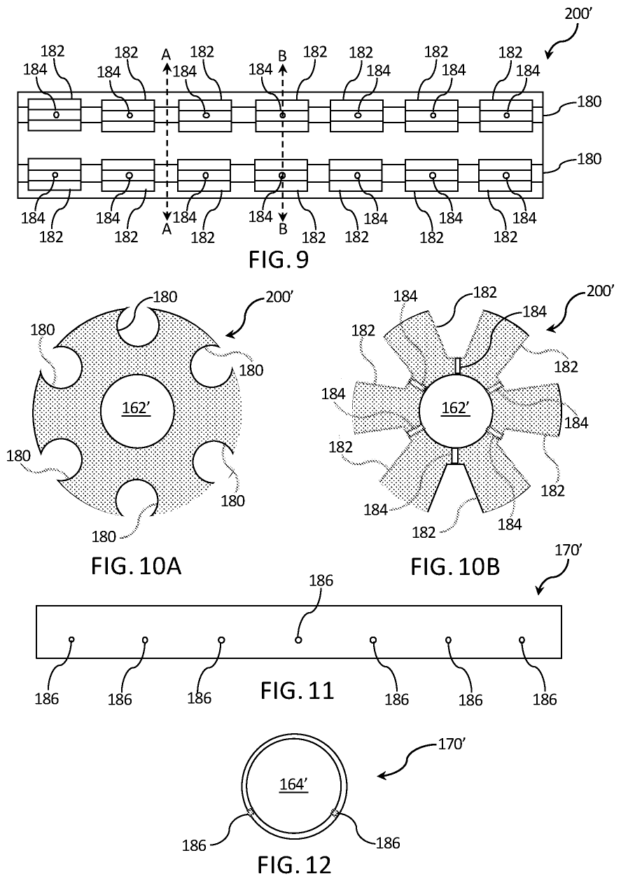

FIG. 9 shows a schematic side view of an example heat extractor 200′ in accordance with embodiments disclosed herein. FIGS. 10A and 10B show schematic end cutaways views of the example heat extractor 200′ of FIG. 9, wherein FIG. 10A shows a cutaway view taken along line A-A of FIG. 9 and FIG. 10B shows a cutaway view taken along line B-B of FIG. 9.

Heat extractor 200′ comprises a substantially cylindrical body of which first conduit 162′ extends along a central axis. Heat extractor 200′ further comprises a plurality of holding channels 180 extending along an axial length of heat extractor 200′ and circumferentially surrounding portions of first conduit 162′. In addition, heat extractor 200′ comprises a plurality of cavities 182 periodically extending along each holding channel 180. Heat extractor 200′ additionally comprises a plurality of radially extending channels 184, each radially extending channel 184 extending between the first conduit 162′ and one of the plurality of cavities 182.

FIGS. 11 and 12 show, respectively, schematic side and end cutaway views of an example fluid transfer mechanism 170′ in accordance with embodiments disclosed herein. Fluid transfer mechanism 170′ comprises a substantially cylindrical body of which second conduit 164′ extends along a central axis. Fluid transfer mechanism 170′ also comprises a plurality of apertures 186 extending along its axial length. And while apertures 186 are shown in FIG. 12 as being positioned about 120 degrees apart, embodiments disclosed herein include those in which apertures 186 are positioned at other orientations relative to each other.

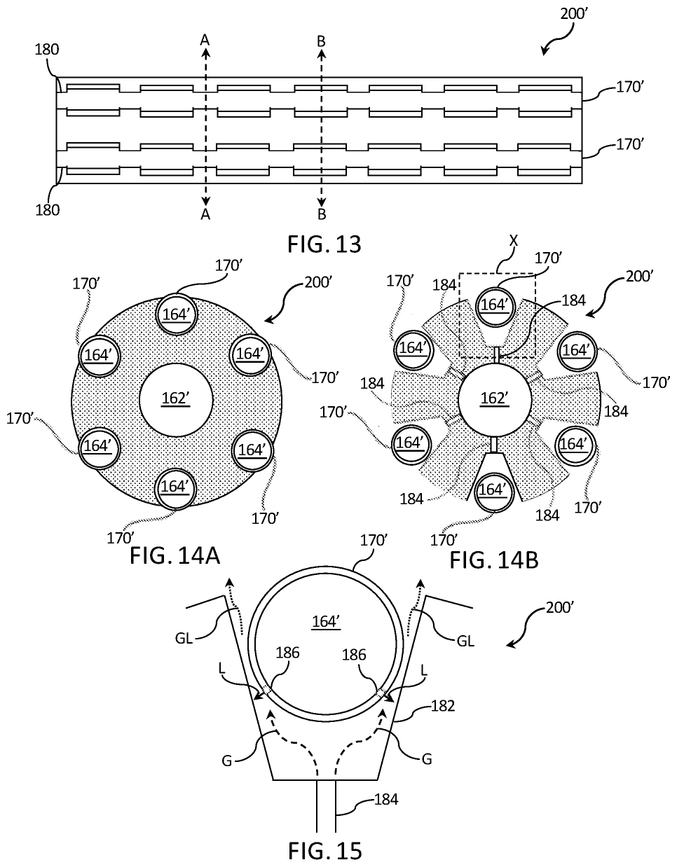

FIG. 13 shows a schematic side view of an example heat extractor 200′ in accordance with embodiments disclosed herein. FIGS. 14A and 14B show schematic end cutaways views of the example heat extractor 200′ of FIG. 13, wherein FIG. 14A shows a cutaway view taken along line A-A of FIG. 13 and FIG. 14B shows a cutaway view taken along line B-B of FIG. 13.

Heat extractor 200′ comprises a substantially cylindrical body of which first conduit 162′ extends along a central axis. Heat extractor 200′ also comprises a plurality of fluid transfer mechanisms 170′, each of the plurality of fluid transfer mechanisms 170′ positioned along a holding channel 180 of heat extractor 200′ and each of the plurality of fluid transfer mechanisms 170′ comprising a substantially cylindrical body of which second conduit 164′ extends along a central axis. Heat extractor 200′ additionally comprises a plurality of radially extending channels 184, each radially extending channel 184 extending between the first conduit 162′ and a second conduit 164′.

Embodiments disclosed herein include those in which first conduit 162′ is configured to flow a gas therethrough and plurality of second conduits 164′ are configured to flow a liquid therethrough such that extracting heat via heat extractor 200′ comprises flowing a gas through first conduit 162′ and a liquid through each of the plurality of second conduits 164′. In certain exemplary embodiments, the gas can comprise air and the liquid can comprise water.

FIG. 15 shows a schematic end cutaway view of a portion of the heat extractor 200′ of FIG. 14B. Specifically, FIG. 15 shows a schematic end cutaway view of the portion of heat extractor 200′ shown in area X of FIG. 14B. As shown in FIG. 15, fluid transfer mechanism 170′ extends inside cavity 182 of heat extractor 200′. As further shown in FIG. 15, gas (as illustrated by dashed arrows G) is flowed from radially extending channel 184 (which is, in turn, flowed into radially extending channel 184 from first conduit 162′) toward fluid transfer mechanism 170′ comprising second conduit 164′, such that gas is flowed from first conduit 162′ toward second conduit 164′ via radially extending channel 184. Meanwhile, liquid (as illustrated by solid arrows L) is flowed from second conduit 164′ through apertures 186 and toward gas flowed from first conduit 162′. Gas liquid mixture (as illustrated by dotted arrows GL) is then flowed radially outward toward periphery of heat extractor 200′.

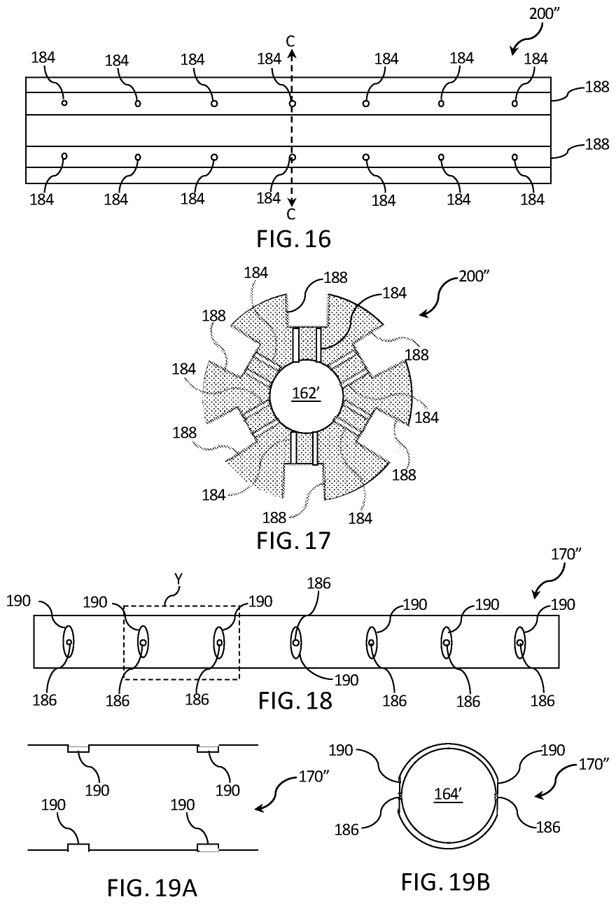

FIG. 16 shows a schematic side view of an example heat extractor 200″ in accordance with embodiments disclosed herein. FIG. 17 shows a schematic end cutaway view of the example heat extractor 200″ of FIG. 16 taken along line C-C of FIG. 16. Heat extractor 200″ comprises a substantially cylindrical body of which first conduit 162′ extends along a central axis. Heat extractor 200″ further comprises a plurality of cavities 188 extending along an axial length of heat extractor 200″ and circumferentially surrounding portions of first conduit 162′. Heat extractor 200″ additionally comprises a plurality of radially extending channels 184, each radially extending channel 184 extending between the first conduit 162′ and one of the plurality of cavities 188.

FIG. 18 shows a schematic side view of an example fluid transfer mechanism 170″ in accordance with embodiments disclosed herein, FIG. 19A shows a side view of a portion of fluid transfer mechanism 170″ shown in area Y of FIG. 18 that has been rotated by 90 degrees, and FIG. 19B shows a schematic end cutaway view of fluid transfer mechanism 170″. Fluid transfer mechanism 170″ comprises a substantially cylindrical body of which second conduit 164′ extends along a central axis. Fluid transfer mechanism 170″ also comprises a plurality of apertures 186 extending along its axial length. In addition, fluid transfer mechanism 170″ comprises a plurality of grooves 190, each groove 190 extending along a portion of an outer circumferential area of fluid transfer mechanism 170″ that encompasses each aperture 186. And while apertures 186 are shown in FIG. 19B as being positioned about 180 degrees apart, embodiments disclosed herein include those in which apertures 186 are positioned at other orientations relative to each other.

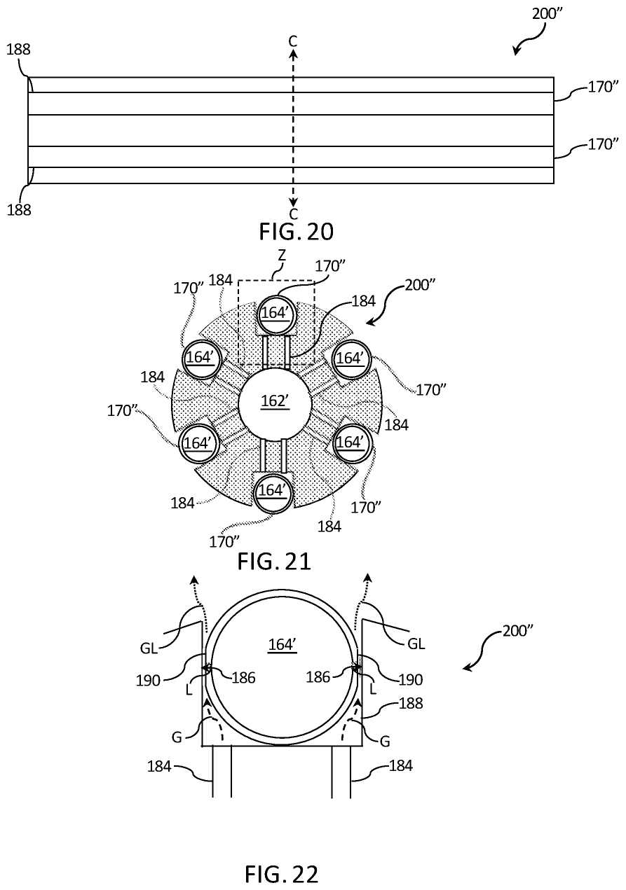

FIG. 20 shows a schematic side view of an example heat extractor 200″ in accordance with embodiments disclosed herein. FIG. 21 shows a schematic end cutaway view of the example heat extractor 200″ of FIG. 16 taken along line C-C of FIG. 20. Heat extractor 200″ comprises a substantially cylindrical body of which first conduit 162′ extends along a central axis. Heat extractor 200″ also comprises a plurality of fluid transfer mechanisms 170″, each of the plurality of fluid transfer mechanisms 170″ positioned along a cavity 188 of heat extractor 200″ and each of the plurality of fluid transfer mechanisms 170″ comprising a substantially cylindrical body of which second conduit 164′ extends along a central axis. Heat extractor 200″ additionally comprises a plurality of radially extending channels 184, each radially extending channel 184 extending between the first conduit 162′ and a second conduit 164′.

Embodiments disclosed herein include those in which first conduit 162′ is configured to flow a gas therethrough and plurality of second conduits 164′ are configured to flow a liquid therethrough such that extracting heat via heat extractor 200″ comprises flowing a gas through first conduit 162′ and a liquid through each of the plurality of second conduits 164′. In certain exemplary embodiments, the gas can comprise air and the liquid can comprise water.

FIG. 22 shows a schematic end cutaway view of a portion of the heat extractor 200″ of FIG. 21. Specifically, FIG. 22 shows a schematic end cutaway view of the portion of heat extractor 200″ shown in area Z of FIG. 21. As shown in FIG. 22, fluid transfer mechanism 170″ extends inside cavity 188 of heat extractor 200″. As further shown in FIG. 21, gas (as illustrated by dashed arrows G) is flowed from radially extending channels 184 (which is, in turn, flowed into radially extending channels 184 from first conduit 162′) toward fluid transfer mechanism 170″ comprising second conduit 164′, such that gas is flowed from first conduit 162′ toward second conduit 164′ via radially extending channels 184. Meanwhile, liquid (as illustrated by solid arrows L) is flowed from second conduit 164′ through apertures 186 and toward gas flowed from first conduit 162′ via groove 190. Gas liquid mixture (as illustrated by dotted arrows GL) is then flowed radially outward toward periphery of heat extractor 200″.

Fluid transfer channels 170″ may be interference fit into cavities 188 of heat extractor 200″ and may be secured to heat extractor 200″ using methods known to persons having ordinary skill in the art, such as brazing and/or welding.

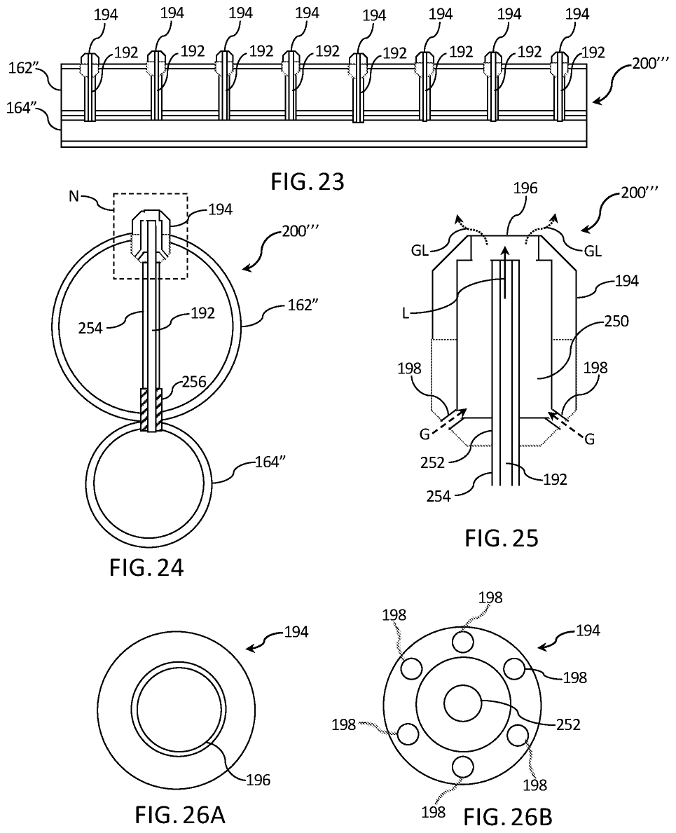

FIG. 23 shows a schematic side cutaway view of an example heat extractor 200″″′ in accordance with embodiments disclosed herein. FIG. 24 shows a schematic end cutaway view of the example heat extractor 200″′ of FIG. 23. Heat extractor 200′″ comprises two cylindrical bodies extending along generally parallel axes, wherein a first conduit 162″ extends along a first axis and a second conduit 164″ extends along a second axis. Heat extractor 200′″ also includes a plurality of channels 192, each of the plurality of channels 192 extending across a diameter of first conduit 162″ and configured to flow fluid from second conduit 164″ and toward a nozzle 194 configured to admix fluid from the first conduit 162″ with the fluid flowed from the second conduit 164″. Each channel 192 extends within a fluid transfer mechanism 254 that includes fastening component 256 (e.g., threaded member) for securing fluid transfer mechanism 254 to first conduit 162″ and/or second conduit 164″.

In certain exemplary embodiments, first conduit 162″ is configured to flow a gas, such as air, therethrough and second conduit 164″ is configured to flow a liquid, such as water, therethrough. Accordingly, embodiments disclosed herein include those in which each of the plurality of channels 192 is configured to flow liquid from second conduit 164″ and toward nozzle 194 configured to admix gas from the first conduit 162″ with the liquid flowed from second conduit 164″.

FIG. 25 shows a schematic end cutaway view of a portion of the heat extractor 200″″ of FIG. 24. Specifically, FIG. 25 shows a schematic end cutaway view of the portion of heat extractor 200′″ shown in area N of FIG. 24. As shown in FIG. 25, fluid transfer mechanism 254 extends through entry aperture 252 and inside cavity 250 of nozzle 194. As further shown in FIG. 25, gas (as illustrated by dashed arrows G) is flowed into cavity 250 via radial apertures 198. Meanwhile, liquid (as illustrated by solid arrow L) is flowed into cavity 250 from channel 192. Gas liquid mixture (as illustrated by dotted arrows GL) is then flowed out of cavity 250 via exit aperture 196.

FIGS. 26A and 26B show, respectively, schematic top and bottom views of an example nozzle 194 in accordance with embodiments disclosed herein. Nozzle 194 includes exit aperture 196 and entry aperture 252 which is circumferentially surrounded by radial apertures 198.

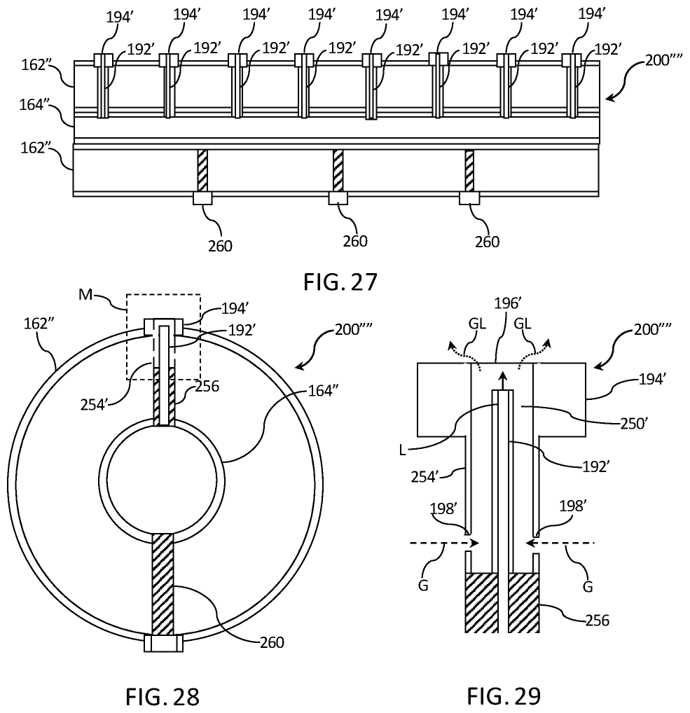

FIG. 27 shows a schematic side cutaway view of an example heat extractor 200″″ in accordance with embodiments disclosed herein. FIG. 28 shows a schematic end cutaway view of the example heat extractor 200″″ of FIG. 27. Heat extractor 200″″ comprises two cylindrical bodies extending along the same axis, wherein a first conduit 162″ circumferentially surrounds a second conduit 164″ such that second conduit 164″ is sleeved within first conduit 162″. Heat extractor 200″ also includes a plurality of channels 192′, each of the plurality of channels 192′ extending across a radial length of first conduit 162″ and configured to flow fluid from second conduit 164″ and toward a head region 194′ configured to admix fluid from the first conduit 162″ with the fluid flowed from the second conduit 164″. Each channel 192′ extends within a fluid transfer mechanism 254′ that includes fastening component 256 (e.g., threaded member) for securing fluid transfer mechanism 254′ to first conduit 162″ and/or second conduit 164″.

Heat extractor 200″″ also includes fastening components 260 (e.g., threaded members) extending across an opposite radial length of first conduit 162″ as channels 192′ for positioning and securing second conduit 164″ within first conduit 162″.

In certain exemplary embodiments, first conduit 162″ is configured to flow a gas, such as air, therethrough and second conduit 164″ is configured to flow a liquid, such as water, therethrough. Accordingly, embodiments disclosed herein include those in which each of the plurality of channels 192′ is configured to flow liquid from second conduit 164″ and toward head region 194′ configured to admix gas from the first conduit 162″ with the liquid flowed from second conduit 164″.

FIG. 29 shows a schematic end cutaway view of a portion of the heat extractor 200″″ of FIG. 28. Specifically, FIG. 29 shows a schematic end cutaway view of the portion of heat extractor 200″ shown in area M of FIG. 28. As shown in FIG. 29, gas (as illustrated by dashed arrows G) is flowed into cavity 250′ via radial apertures 198′. Meanwhile, liquid (as illustrated by solid arrow L) is flowed into cavity 250′ from channel 192′. Gas liquid mixture (as illustrated by dotted arrows GL) is then flowed out of cavity 250′ via exit aperture 196′.

In certain exemplary embodiments, gas, such as air, flowed through heat extractors 200′, 200″, 200′″ and/or 200″ is flowed along an axial length of first conduit 162′ in the same direction as liquid, such as water, flowed through fluid transfer mechanism 170′ and/or 170″. In certain exemplary embodiments, gas, such as air, flowed through heat extractors 200′, 200″ and/or 200′″ is flowed along an axial length of first conduit 162′ in the opposite direction as liquid, such as water, flowed through fluid transfer mechanism 170′ and/or 170″.

In certain exemplary embodiments, a control mechanism (not shown), such as a feedback or feedforward control mechanism may be used to control or adjust one or more parameters, such as flowrate or temperature, of gas flowing through heat extractors 200′, 200″, 200″″′, and/or 200″ and may also be used to control or adjust one or more parameters, such as flowrate or temperature, of liquid flowing through fluid transfer mechanism 170′ and/or 170″.

While FIGS. 9-29 show generally cylindrical heat extractors 200′, 200″, 200″, and 200″″ with generally circular cross sections and generally cylindrical fluid transfer mechanisms 170′ and 170″, embodiments disclosed herein include those in which heat extractors 200′, 200″, 200″″ and/or 200″ and/or fluid transfer mechanism 170′ and/or 170″ have other shapes, such as those with polygonal cross sections.

Embodiments disclosed herein include those in which heat extractors 200, 200′, 200″, 200′″, and/or 200″″ are sleeved within a larger diameter roll that circumferentially surrounds the heat extractor 200, 200′, 200″, 200′″, and/or 200″″. For example, heat extractors 200, 200′, 200″, 200′″, and/or 200″″ may be sleeved within a single forming roll 160 and/or an opposing pair of forming rolls 100.

Embodiments disclosed herein can also include a system comprising one or more apparatuses for manufacturing glass. For example, embodiments disclosed herein can include a system for manufacturing glass comprising a heat extractor that extracts heat from molten glass wherein the heat extractor includes a first conduit and a plurality of second conduits circumferentially surrounding the first conduit, the first conduit and the plurality of second conduits extending along a length of the heat extractor. A fluid, such as a liquid or a gas, flows through the first conduit and fluid, such as a liquid or a gas, flows through the plurality of second conduits.

Embodiments disclosed herein can enable the efficient and reliable production of glass articles with desired attributes under a variety of processing conditions, including but not limited to those in which variables relating to at least one of temperature, viscosity, flowrate, liquidus viscosity, and/or liquidus temperature of the molten glass may be present.

Embodiments disclosed herein also include glass articles, including glass sheets, made by methods described herein as well as electronic devices incorporating such glass articles.

While the above embodiments have been described with reference to a slot draw process, it is to be understood that such embodiments are also applicable to other glass forming processes, such as fusion draw processes, float processes, up-draw processes, tube drawing processes, and press-rolling processes.

It will be apparent to those skilled in the art that various modifications and variations can be made to embodiment of the present disclosure without departing from the spirit and scope of the disclosure. Thus, it is intended that the present disclosure cover such modifications and variations provided they come within the scope of the appended claims and their equivalents.

1. An apparatus for manufacturing glass comprising:
a heat extractor configured to extract heat from molten glass, the heat extractor comprising a first conduit and at least one second conduit, the first conduit and the at least one second conduit extending along a length of the heat extractor, the first conduit and the at least one second conduit each configured to flow a fluid therethrough.

2. The apparatus of claim 1, wherein the first conduit is configured to flow a liquid therethrough and the at least one second conduit comprises a plurality of second conduits that circumferentially surround the first conduit and are configured to flow a gas therethrough.

3. The apparatus of claim 1, wherein the heat extractor comprises a substantially cylindrical body and the first conduit extends along a central axis of the substantially cylindrical body.

4. The apparatus of claim 1, wherein the heat extractor is configured to contact the molten glass.

5. The apparatus of claim 3, wherein the heat extractor comprises a single forming roll configured to contact a first side of a glass ribbon flowing from a glass delivery device.

6. The apparatus of claim 3, wherein the heat extractor comprises an opposing pair of forming rolls, each forming roll of the opposing pair configured to contact opposing sides of a glass ribbon flowing from a glass delivery device.

7. The apparatus of claim 2, wherein the first conduit is configured to flow the liquid in a first direction along the length of the heat extractor, at least one of the second conduits is configured to flow the gas in the first direction, and at least one of the second conduits is configured to flow the gas in an opposing second direction along the length of the heat extractor.

8. The apparatus of claim 7, wherein the apparatus further comprises a fluid transfer mechanism in fluid communication with the heat extractor, the fluid transfer mechanism comprising a gas inlet conduit configured to feed gas into the plurality of second conduits of the heat extractor, a gas outlet conduit configured to receive gas from the plurality of second conduits of the heat extractor, a liquid inlet conduit configured to feed liquid into the first conduit of the heat extractor, and a liquid outlet conduit configured to receive liquid from the first conduit of the heat extractor.

9. The apparatus of claim 8, wherein the fluid transfer mechanism comprises a first section in fluid communication with a first end of the heat extractor and a second section in fluid communication with a second end of the heat extractor, wherein, in the first section, the gas inlet conduit circumferentially surrounds the gas outlet conduit and the gas outlet conduit circumferentially surrounds the liquid inlet conduit and, in the second section, the gas inlet conduit circumferentially surrounds the gas outlet conduit and the gas outlet conduit circumferentially surrounds the liquid outlet conduit.

10. The apparatus of claim 1, wherein the heat extractor comprises a material having a thermal conductivity at 25° C. ranging from about 10 W/m·K to about 500 W/m·K.

11. The apparatus of claim 1, wherein the first conduit is configured to flow a gas therethrough and the at least one second conduit is configured to flow a liquid therethrough.

12. The apparatus of claim 11, wherein the apparatus comprises a plurality of channels configured to flow liquid from the at least one second conduit and toward a nozzle or head region configured to admix gas from the first conduit with the liquid.

13. The apparatus of claim 11, wherein the at least one second conduit comprises a plurality of second conduits that circumferentially surround the first conduit.

14. The apparatus of claim 13, wherein the apparatus comprises a plurality of radially extending channels, each radially extending channel extending between the first conduit and at least one of the plurality of second conduits and configured to flow gas from the first conduit and toward at least one of the plurality of second conduits.

15. The apparatus of claim 13, wherein each of the plurality of second conduits extend along the axial length of a fluid transfer mechanism comprising a plurality of apertures extending along the axial length, each of the plurality of apertures configured to flow liquid from each of the plurality of second conduits.

16. The apparatus of claim 2, wherein the liquid comprises water and the gas comprises air.

17. A method for manufacturing glass comprising:
flowing molten glass from a glass delivery device;
extracting heat from the molten glass with a heat extractor, the heat extractor comprising a first conduit and at least one second conduit, the first conduit and the at least one second conduit extending along a length of the heat extractor, and the extracting comprising flowing a fluid through the first conduit and the at least one second conduit.

18. The method of claim 15, wherein the at least one second conduit comprises a plurality of second conduits that circumferentially surround the first conduit and the extracting comprises flowing a liquid through the first conduit and a gas through each of the plurality of second conduits.

19. The method of claim 17, wherein the heat extractor comprises a substantially cylindrical body and the first conduit extends along a central axis of the substantially cylindrical body.

20. The method of claim 17, wherein the heat extractor contacts the molten glass.

21. The method of claim 20, wherein the heat extractor comprises a single forming roll that contacts a first side of a glass ribbon flowing from the glass delivery device.

22. The method of claim 21, wherein a viscosity of the glass ribbon prior to contacting the forming roll ranges from about 1 poise (P) to about 10 kilopoise (kP) and the viscosity of the glass ribbon subsequent to contacting the forming roll ranges from about 50 kilopoise (kP) to about 500 kilopoise (kP).

23. The method of claim 22, wherein the heat extractor comprises a first end proximate a first widthwise end of the glass ribbon and a second end proximate a second widthwise end of the glass ribbon, wherein a surface temperature of the first end of the heat extractor is within about 5° C. of a surface temperature of the second end of the heat extractor.

24. The method of claim 20, wherein the heat extractor comprises an opposing pair of forming rolls, each forming roll of the opposing pair contacting opposing sides of a glass ribbon flowing from the glass delivery device.

25. The method of claim 18, wherein the liquid flows in the first conduit in a first direction along the length of the heat extractor, a gas flows in at least one of the second conduits in the first direction, and a gas flows in at least one of the second conduits in an opposing second direction along the length of the heat extractor.

26. The method of claim 18, wherein an amount of heat extracted from the molten glass is changed by changing at least one of: a flowrate of the liquid through the first conduit, a temperature of the liquid flowing through the first conduit, a flowrate of at least one gas through at least one of the plurality of second conduits, or a temperature of at least one gas flowing through at least one of the plurality of second conduits.

27. The method of claim 17, wherein the extracting comprises flow a gas through the first conduit and a liquid through the at least one second conduit.

28. The method of claim 27, wherein the extracting comprises flowing liquid through a plurality of channels from the at least one second conduit and toward a nozzle or head region that admixes gas from the first conduit with the liquid.

29. The method of claim 27, wherein the at least one second conduit comprises a plurality of second conduits that circumferentially surround the first conduit.

30. The method of claim 29, wherein the apparatus comprises a plurality of radially extending channels, each radially extending channel extending between the first conduit and at least one of the plurality of second conduits and the extracting comprises flowing gas from the first conduit and toward at least one of the plurality of second conduits.

31. The method of claim 30, wherein each of the plurality of second conduits extend along an axial length of a fluid transfer mechanism comprising a plurality of apertures extending along the axial length and the extracting comprises flowing liquid from each of the plurality of second conduits through each of the plurality of apertures and toward the gas flowed from the first conduit and toward at least one of the plurality of second conduits.

32. The method of claim 18, wherein the liquid comprises water and the gas comprises air.

33. A glass article made by the method of claim 17.

34. An electronic device comprising the glass article of claim 33.
